(19) United States
(12) Patent Application Publication
(10) Pub. No.: US 2015/0207715 A1
(43) Pub. Date: Jul. 23, 2015

(54) RECEIVING APPARATUS, TRANSMITTING APPARATUS, COMMUNICATION SYSTEM, CONTROL METHOD FOR RECEIVING APPARATUS, CONTROL METHOD FOR TRANSMITTING APPARATUS, AND RECORDING MEDIUM

(71) Applicant: CANON KABUSHIKI KAISHA, Tokyo (JP)

(72) Inventor: Takeshi Ozawa, Kawasaki-shi (JP)

(21) Appl. No.: 14/600,284

(22) Filed: Jan. 20, 2015

(30) Foreign Application Priority Data
Jan. 20, 2014 (JP) 2014-007811

(51) Int. Cl. H04L 12/26

(52) U.S. Cl. CPC H04L 43/0864

(57) ABSTRACT

A receiving apparatus includes a receiving unit configured to receive encoded data in packets from a transmitting apparatus through a plurality of transmission paths including a first transmission path and a second transmission path, and a notifying unit configured to notify the transmitting apparatus of information describing a time period from reception of a first packet containing data in units of decoding through the first transmission path to reception of a second packet containing data in the units of decoding through the second transmission path.

### BACKGROUND

1. Technical Field

The present invention relates to a receiving apparatus, a transmitting apparatus, a communication system, a control method for a receiving apparatus, a control method for a transmitting apparatus, and a recording medium recording a program usable for transmitting and receiving a content.

2. Description of the Related Art

In recent years, stream transmission services for moving picture data over the Internet have widely spread. The number of pixels of display devices has been increased, and high-definition (HD) display devices have increasingly been available. More mobile apparatuses capable of reproducing full HD moving picture data have been widely spread. As a scheme for encoding a moving-picture, H.265 (ISO/IEC 23008-2, HEVC) supporting 4K2K and 8K4K mega pixel video images has been standardized, and increases of frame rates have been examined for higher image quality. For example, SHV (super high vision) standard recommended by ITU-R in 2012 supports 120 frames per second (120 fps).

On the other hand, because of the increased capacity of the Internet, high speed data transmission schemes such as LTE (Long Term Evolution) have been applied as wireless communication schemes used in mobile apparatuses. However, this transmission scheme may not transmit mega-pixel and high frame-rate moving picture data in a stable manner.

A multipath transmission technology has been known as one of stream transmission methods for massive moving picture data. A multipath transmission technology refers to a technology which provides a plurality of transmission paths (multipath) usable between a transmitting apparatus and a receiving apparatus for parallel data transmission. Mobile apparatuses today have two or more transmission paths because they are capable of using a wireless LAN (Wi-Fi) line in addition to the LTE line.

IETF, draft-singh-avtcore-mprtp-06.txt proposes MPRTP (MultiPath RTP) as one system for implementing such a multi-path transmission technology. MPRTP is an extension protocol of RTP that is a stream transmission protocol in the past which transmits data through a plurality of paths. In order for a transmitting apparatus to grasp a congestion state of a transmission path, MPRTP uses MPRTCP (RTCP Extension for MPRTP) which is an extension of RTCP in the past for a plurality of paths. MPRTCP notifies an RTT (Round Trip Time) and a packet loss rate to a transmitting apparatus, like RTCP in the past, and notifications of communication states are processed for each path.

MPRTP: Multipath Considerations for Real-time Media, VarunSingh, Alto University Espoo, Finland, et al. discloses re-sorting of transmit packets based on transmission delays and throughputs over a plurality of paths by using PRTP/MPRTCP.

In the past, a transmittable bandwidth is predicted for each path based on a packet loss rate and an RTT (Round-Trip Time), and in accordance with the prediction result, the number of transmitting packets is determined for each path. Packets are sorted to a plurality of paths based on such a prediction in order to transmit moving picture data through multipath. However, in some cases, differences may occur in transmission time between paths. Occurrence of a difference in transmission time may delay the starting time for decoding a moving picture frame in a receiving apparatus. In other words, when arrival of partial packets in a frame delays through a path having a large delay, packets necessary for decoding the frame must be arrived to the receiving apparatus before the decoding is executed. Because many packets waiting for decoding start are retained in a receive buffer as a result, a more space of memory is used in the receiving apparatus.

Because a transmittable bandwidth is predicted for each path based on a packet loss rate and an RTT (Round-Trip Time) in the past, a delay of a decoding process may not be reflected to sorting of packets.

### SUMMARY

A receiving apparatus according to an embodiment includes a receiving unit configured to receive encoded data in packets from a transmitting apparatus through a plurality of transmission paths including a first transmission path and a second transmission path, and a notifying unit configured to notify the transmitting apparatus of information describing a time period from reception of a first packet containing data in units of decoding through the first transmission path to reception of a second packet containing data in the units of decoding through the second transmission path.

Further features of the present invention will become apparent from the following description of exemplary embodiments with reference to the attached drawings.

### BRIEF DESCRIPTION OF THE DRAWINGS

FIG. 1 illustrates an overall configuration example of a communication system according to an embodiment of the present invention.

FIG. 2 is a block diagram illustrating a functional configuration example of a transmitting apparatus according to an embodiment of the present invention.

FIG. 3 is a block diagram illustrating a functional configuration example of a receiving apparatus according to an embodiment of the present invention.

FIG. 4 is a timing chart illustrating data exchanges between a transmitting apparatus and a receiving apparatus according to an embodiment of the present invention.

FIG. 5 is a flowchart illustrating an example of a processing procedure for requesting a notification of a decoding delay state caused by a transmission time difference between paths by using MPRTCP by a transmitting apparatus.

FIGS. 6A to 6C illustrate a data configuration example in a packet by MPRTCP.

FIG. 7 is a flowchart illustrating an example of a processing procedure for receiving an MPRTCP SR packet in a receiving apparatus and then transmitting an MPRTCP RR packet.

### DESCRIPTION OF THE EMBODIMENTS

Details of embodiments will be described with reference to drawings. It should be noted that configurations will be given in embodiments below for illustration purpose only, and the present invention is not limited by such illustrated configurations.

According to an embodiment, a multi-path transmission technology is used to transmit encoded moving picture data over a network. More specifically, a configuration will be described in which moving picture data distributed by a transmitting apparatus that is a network camera present at a remote location is viewed with a receiving apparatus that is a mobile apparatus. Though both of the transmitting apparatus and the receiving apparatus have two network interfaces in the embodiment below, it may only be required that a transmission is actually managed with a plurality of paths at some point on a transmission path by MPRTP. Therefore, the transmitting apparatus and receiving apparatus may substantially have any number of network interfaces.

In the embodiment below, moving picture data to be transmitted are encoded, for example. However, because transmission of a packet included in a decodable unit and its delay are managed, the present invention applicable to contents such as encoded audio data and hierarchically encoded moving picture data. Publicly known methods are applied for multipath connection establishment and for MPRTP/MPRTCP packetizing.

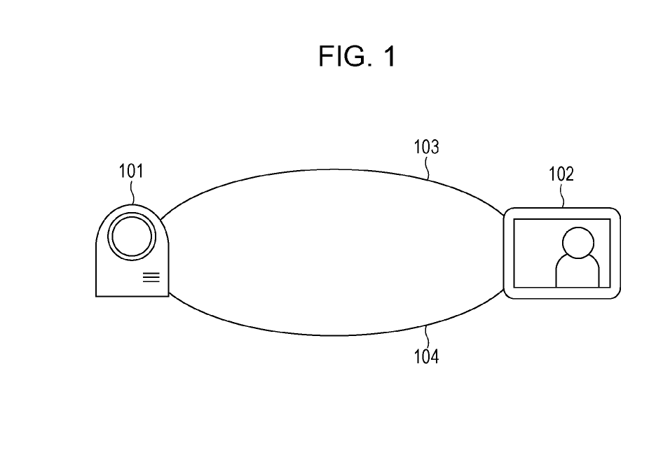

FIG. 1 illustrates an overall configuration example of a communication system according to an embodiment.

As illustrated in FIG. 1, a transmitting apparatus 101 that is a moving picture distribution server performs streaming transmission in real time of encoded moving picture data as a packet to a receiving apparatus 102 present at a remote location over a network. The transmitting apparatus 101 and receiving apparatus 102 are connected through transmission paths including a first path 103 and a second path 104 and apply MPRTP/MPRTCP for multipath transmission. The transmitting apparatus 101 transmits a packet by selecting one of the two transmission paths at a correct time. The receiving apparatus 102 receives a packet transmitted through one of the two transmission paths.

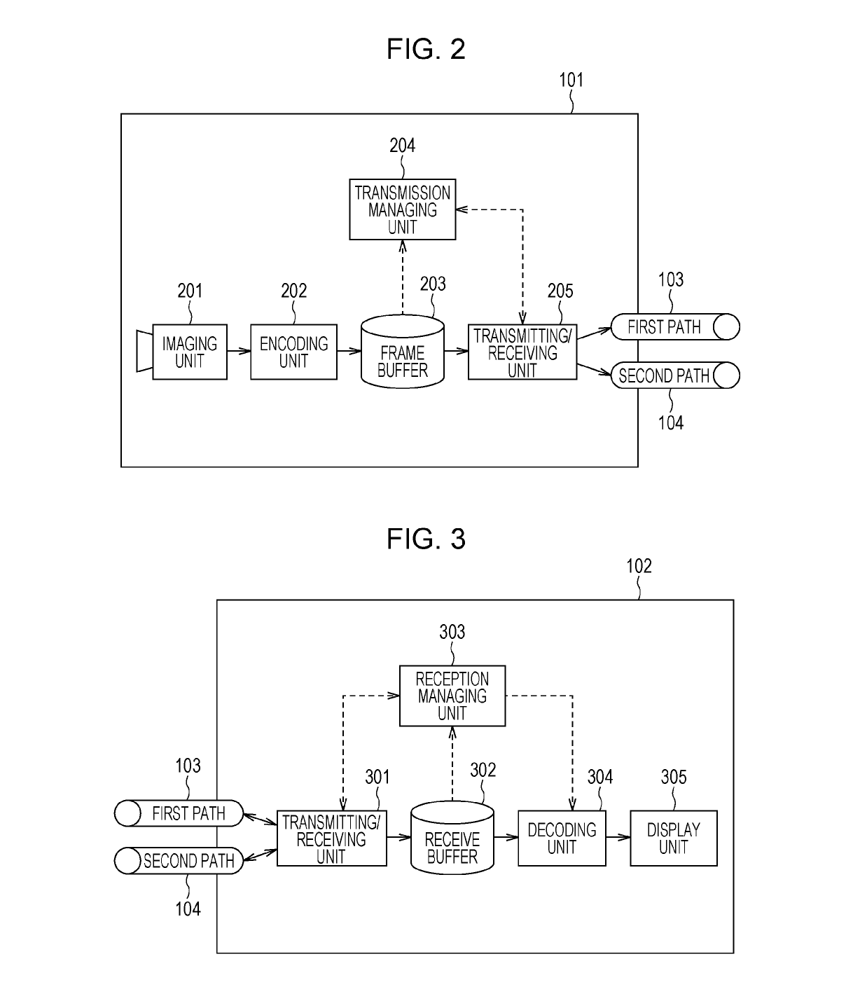

FIG. 2 is a block diagram illustrating a functional configuration example of the transmitting apparatus 101 according to this embodiment.

Referring to FIG. 2, an image capturing unit 201 images a subject and acquires video image data. An encoding unit 202 encodes the video image data, multiplexes encoded audio data acquired by using a microphone, not illustrated, and stores the acquired moving picture data once in a frame buffer 203. A transmission managing unit 204 manages transmission of moving picture data stored in the frame buffer 203. More specifically, the transmission managing unit 204 instructs a transmitting/receiving unit 205 to divide moving picture data into packets based on MPRTP and to transmit the packets to a designated path. The transmitting/receiving unit 205 packetizes moving picture data in response to an instruction from the transmission managing unit 204 and transmits packets to a designated path.

The transmitting/receiving unit 205 transmits encoded contents in packets to the receiving apparatus through a plurality of transmission paths including a first transmission path and second transmission path.

The transmitting/receiving unit 205 acquires from the receiving apparatus information on a time period from reception of a first packet containing data in units of decoding through the first transmission path to reception of a second packet containing data in units of decoding through the second transmission path.

According to this embodiment, the transmission managing unit 204 is configured to instruct an MPRTCP SR (Sender Report) transmission by performing a procedure which will be described below. The transmission managing unit 204 further changes at a correct time packet sorting to a path in accordance with an MPRTCP RR (Receiver Report) content received from the receiving apparatus 102. Information such as an RTT (Round-TripTime) elapsed time is recorded in a memory, not illustrated. RTT refers to a time period from transmission of data from a transmitting apparatus to reception by the transmitting apparatus of a response to the data from a receiving apparatus.

FIG. 3 is a block diagram illustrating a functional configuration example of the receiving apparatus 102.

Referring to FIG. 3, a transmitting/receiving unit 301 receives a packet through the first path 103 or second path 104 and stores it in a receive buffer 302. A reception managing unit 303 monitors a reception state of a packet in the receive buffer 302 and, when a group of packet in a unit of decoding is stored, instructs a decoding unit 304 to decode the group of packets. The decoding unit 304 reads out and decodes the group of packets from the receive buffer 302 in response to a decoding instruction from the reception managing unit 303. A display unit 305 displays a video image relating to the moving picture data acquired by the decoding.

The transmitting/receiving unit 301 receives encoded data in packets from the transmitting apparatus through a plurality of communication paths including a first transmission path and a second transmission path.

The transmitting/receiving unit 301 notifies information representing a time period from reception of a first packet containing data in units of decoding through the first transmission path to reception of a second packet containing the data in units of decoding through the second transmission path to the transmitting apparatus.

The reception managing unit 303 measures a difference between arrival times of packets through the two transmission paths and decoding waiting times in accordance with MPRTCP SR transmitted from the transmitting apparatus 101 by performing a procedure, which will be described below. The results are notified to the transmitting apparatus 101 in accordance with MPRTCP RR. Information such as packet received times and the calculated elapsed time is recorded in a memory, not illustrated.

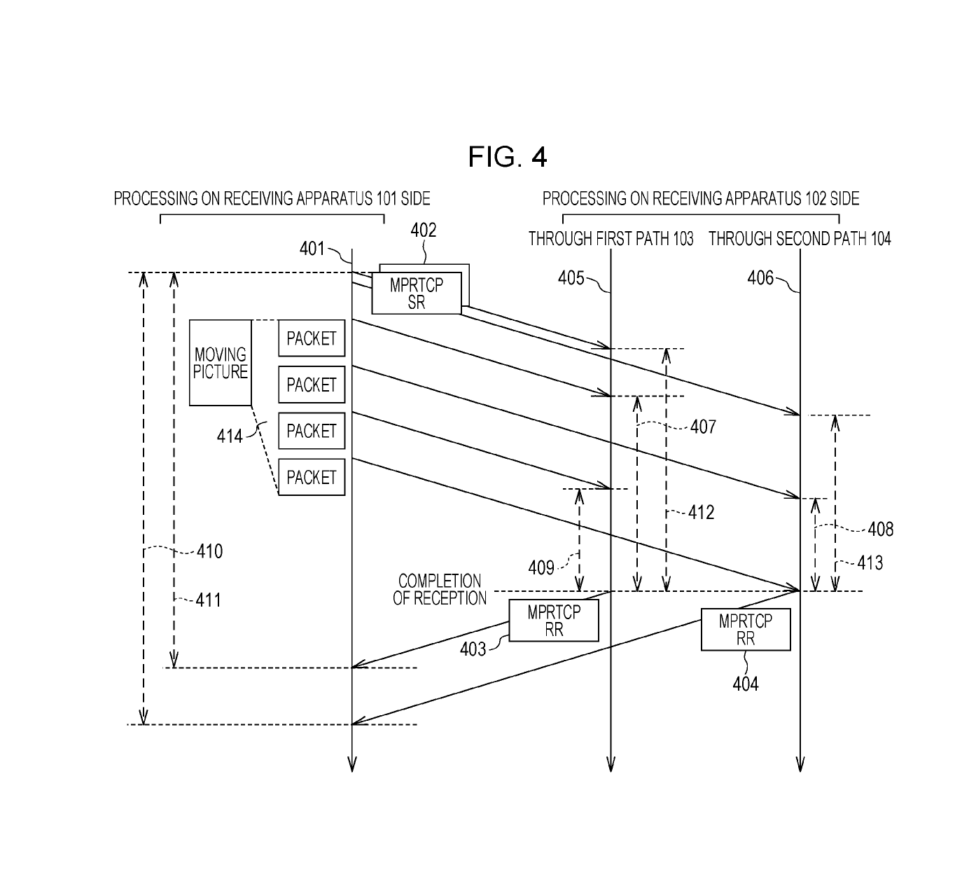

With reference to FIG. 4, the elapsed time of reception of a group of packets of each path and a waiting time until completion of reception will be described as information to be notified from the receiving apparatus 102 to the transmitting apparatus 101 in accordance with MPRTCP.

FIG. 4 is a timing chart illustrating data exchanges between the transmitting apparatus 101 and the receiving apparatus 102.

Referring to FIG. 4, the transmitting apparatus 101 side first transmits an MPRTCP SR packet 402 and then transmits a group of packets 414 divided from moving picture data. The transmitting apparatus 101 receives MPRTCP RR packets 403 and 404 from the receiving apparatus 102.

On the other hand, the receiving apparatus 102 side receives the MPRTCP SR packet 402 through the first path 103 and second path 104 and then receives the group of packets 414 of the moving picture data. The MPRTCP RR packets 403 and 404 are transmitted to the transmitting apparatus 101. It should be noted that this embodiment assumes that the transmission time through the second path 104 is longer than the transmission time through the first path 103. As a result, in a case where the MPRTCP SR packet 402 and the group of packets 414 of moving picture data are to be received, one transmitted through the second path 104 is received subsequently in time to the one transmitted through the first path 103.

According to this embodiment, times 407 and 408 for receiving the group of packets 414 through the first path 103 and the second path 104 are notified from the receiving apparatus 102 to the transmitting apparatus 101. A waiting time 409 from completion of packet reception through the first path 103 to completion of reception through the second path 104 is also notified.

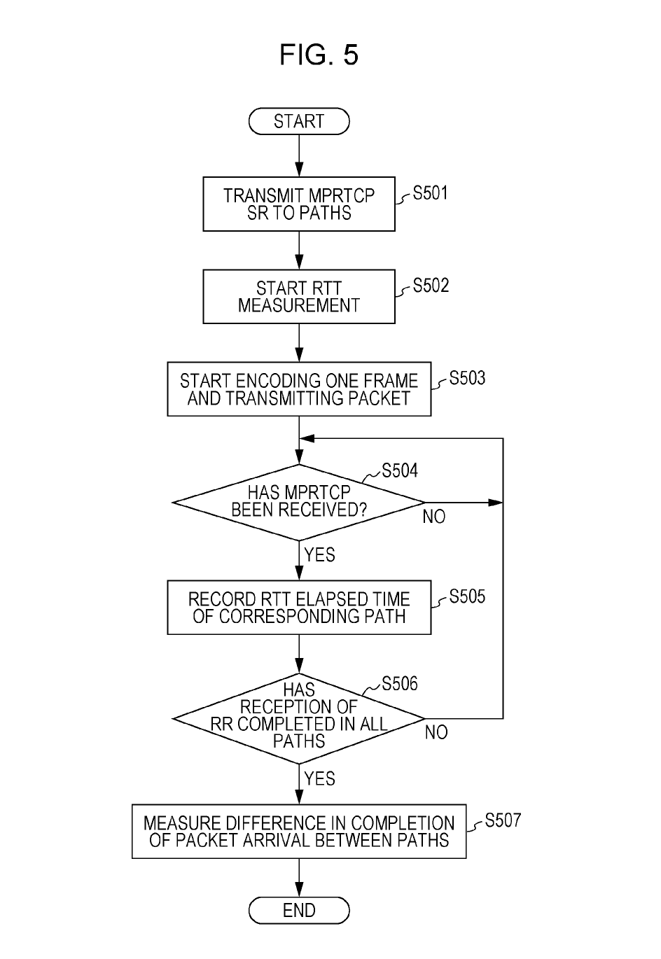

FIG. 5 is a flowchart illustrating an example of a processing procedure for requesting a notification of a decoding delay state due to a transmission time difference between paths in accordance with MPRTCP, which is performed by the transmitting apparatus 101.

First, the transmission managing unit 204 creates an MPRTCP SR packet and transmits it to the receiving apparatus 102 by using the transmitting/receiving unit 205 (S501). This processing transmits the MPRTCP SR packet 402 from both of the first path 103 and second path 104 to the receiving apparatus 102, as illustrated in FIG. 4.

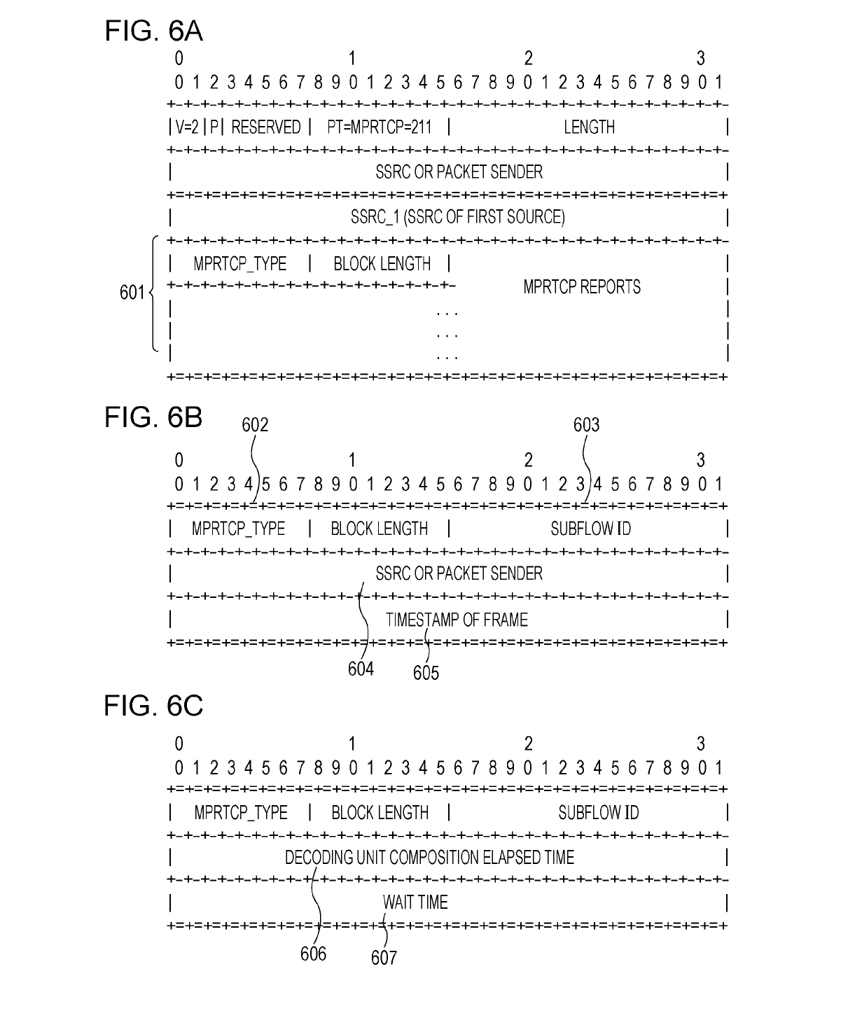

FIG. 6A illustrates a normal data configuration example of a packet based on MPRTCP. A packet based on MPRTCP may contain a partial message in a region 601.

FIG. 6B illustrates a notification request for a decoding delay state as the partial message according to this embodiment. A type value representing a notification request for a decoding delay state is set in a region 602, and a value representing a target subflow is set in a region 603. In order to clearly indicate a packet for which a receiving time period is to be measured, an SSRC of the packet is set in an SSRC region 604, and a time stamp of the packet is set in a region 605. It should be noted that, an MPRTCP packet further contains a publicly known RTT notification request message.

In S501, when an MPRTCP packet is transmitted, the transmission managing unit 204 starts measuring an RTT (S502). The transmitting/receiving unit 205 then starts transmitting a group of packets included in one frame (S503). Those packets are transmitted in parallel through paths determined by a currently predetermined method.

Next, processing waits for reception of the MPRTCP RR packet from the receiving apparatus 102 by using the transmitting/receiving unit 205 (S504). When the MPRTCP RR packet is received from one of paths, the transmission managing unit 204 records an RTT elapsed time measured in S502 regarding the path instructed by the subflow value in the MPRTCP RR packet in a memory, not illustrated (S505). It should be noted that the RTT elapsed time corresponds to time periods 410 and 411 illustrated in FIG. 4.

Whether MPRTCP RR packets have been received from all paths by using the transmitting/receiving unit 205 or not may be determined (S506). If not as a result of the determination, the processing returns to S504. On the other hand, if so as a result of the determination in S506, information including an elapsed time for packet reception through each path and a waiting time until all packets of the packet group is acquired from the received MPRTCP RR packet. Then, the ratio of the information to a waiting time from completion of arrival of packets until they are ready for decoding is measured for each path (S507).

FIG. 6C illustrates an example of a part which reports an influence of a decoding delay for each path in an MPRTCP RR packet returned as a reply message from the receiving apparatus 102. Elapsed time periods 407 and 408 from a time when a first packet is received to a time when all packets are received through the paths, as illustrated in FIG. 4, are set in a region 606. A waiting time 409 until completion of reception of a packet group is set in a region 607. It should be noted that 0 is set to indicate no waiting time in a region 607 for the second path 104.

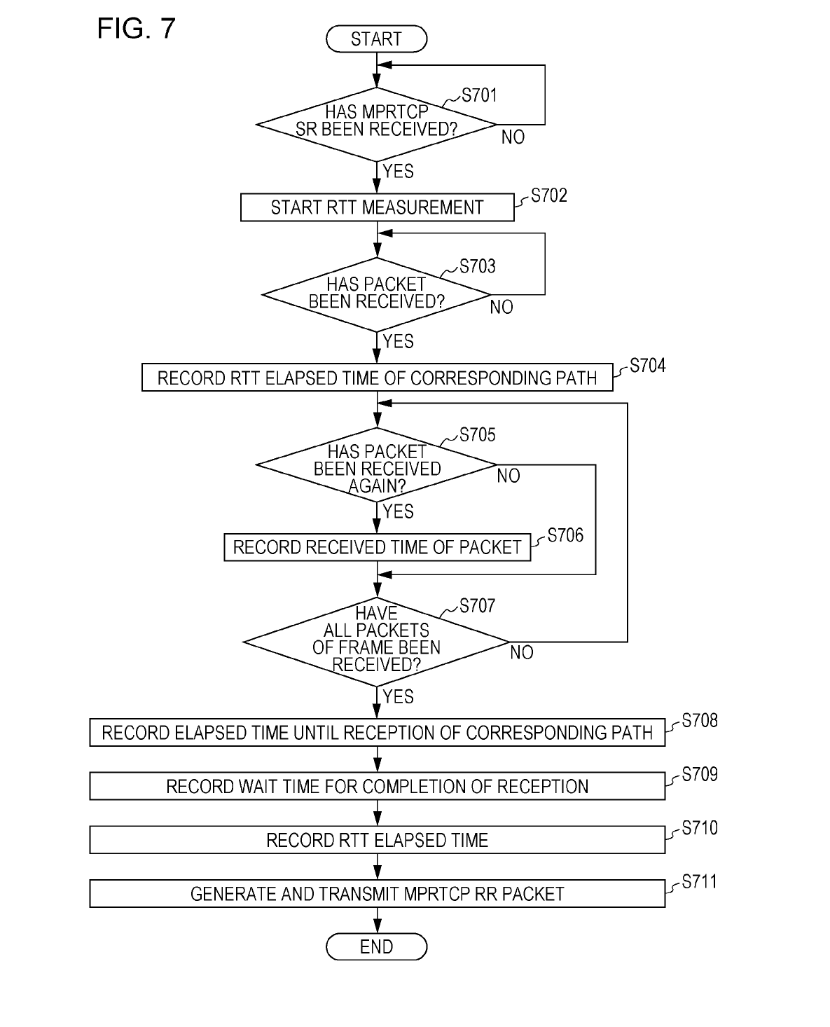

Next, with reference to FIG. 7, processes in the receiving apparatus 102 will be described. The receiving apparatus 102 receives an MPRTCP SR packet, measures a received time and an RTT of the packet of moving picture data, and transmits an MPRTCP RR packet. The MPRTCP RR packet contains a notification of a packet waiting state for each path.

FIG. 7 is a flowchart illustrating an example of a processing procedure for receiving an MPRTCP SR packet by using the receiving apparatus 102 and transmitting an MPRTCP RR packet. It should be noted that the processing illustrated in FIG. 7 is performed for each path.

First, the processing first waits until reception of an MPRTCP SR packet from the transmitting apparatus 101 by using the transmitting/receiving unit 301 (S701). When an MPRTCP SR packet is received, the reception managing unit 303 starts measuring an RTT (S702).

Next, the processing waits until the first packet of a frame of moving picture data designated in the MPRTCP SR packet is received by the transmitting/receiving unit 301 (S703). When a packet of the designated frame is first received, the reception managing unit 303 records the received time of the packet in a memory, not illustrated (S704).

Next, the reception managing unit 303 determines whether a packet of the designated frame has been received again by the transmitting/receiving unit 301 or not is determined (S705). If so as a result of the determination, the reception managing unit 303 records the received time in a memory, not illustrated (S706). On the other hand, if not as a result of the determination in S705, the processing moves to S707. Then, the reception managing unit 303 determines whether all packets included in the frame have been received by the transmitting/receiving unit 301 through all paths or not (S707). If not as a result of the determination, the processing returns to S705.

If so as a result of the determination in S707 on the other hand, the processing moves to S708. An elapsed time from a time when the first packet is received, which is recorded in S704, to a time when all packets are received through all paths is calculated and is recorded in a memory, not illustrated (S708). For example, as illustrated in FIG. 4, a time period 407 is recorded as the elapsed time.

Next, an elapsed time (waiting time) from a time when the last packet is received, which is recorded in S706, to a time when all packets are received through all paths is calculated and is recorded in a memory, not illustrated (S709). This waiting time corresponds a time period 409 illustrated in FIG. 4, for example. The waiting time is equal to 0 for the second path 104.

Next, the reception managing unit 303 records the RTT elapsed time started to measure in S702 in a memory, not illustrated (S710). This elapsed time corresponds to the time periods 412 and 413 illustrated in FIG. 4. The reception managing unit 303 records the time periods recorded in S708 and S709 in an MPRTCPRR packet and transmits it to the transmitting apparatus 101 by using the transmitting/receiving unit 301 (S711).

According to this embodiment as described above, the transmitting apparatus 101 may acquire information describing the elapsed time for each path from a time when a first packet is received to a time when all packets are received and the waiting time from the completion of the reception for each path. For example, the ratios of these two time periods (waiting time from completion of reception/elapsed time from reception of all packets) are compared for each path to determine degrees of influence of waiting for decoding. A higher time ratio may mean that the path has a smaller delay. From this, it may be determined that there may be a space for receiving more packets. On the other hand, a lower time ratio may mean that the path has a larger delay. From this, it may be determined that there may be a need for reducing the number of packets to be transmitted through the path or for transmitting packets earlier.

For example, a case will be described in which a plurality of packets included in one frame are transmitted by using a first communication path, a second communication path, and a third communication path.

Defining the number of packets included in one frame as 100%, the transmitting apparatus 101 may transmit 20% of the number of packets through the first communication path. The transmitting apparatus 101 may transmit 30% of the number of packets through the second communication path. The transmitting apparatus 101 may transmit 50% of the number of packets through the third communication path. In other words, the transmitting apparatus 101 assigns the number of packets included in one frame at a ratio of 2:3:5 to the first communication path, second communication path, and third communication path.

The receiving apparatus 102 acquires a first time when all of packets (20% of the number of packets) transmitted through the first communication path of a plurality of packets included in a first frame which is one frame have been received. The receiving apparatus 102 acquires a second time when all of packets (30% of the number of packets) transmitted through the second communication path of the plurality of packets included in the first frame have been received. The receiving apparatus 102 acquires a third time when all of packets (50% of the number of packets) transmitted through the third communication path of the plurality of packets included in the first frame have been received.

The receiving apparatus 102 transmits the first time, second time and third time to the transmitting apparatus 101.

The transmitting apparatus 101 determines a latest time of the received first time, second time, and third time. For example, if the third time is later than the first time and the second time, the transmitting apparatus 101 determines the third time as a time T when all packets included in the first frame have been received.

Next, the transmitting apparatus 101 evaluates the first to third communication paths. With respect to each of the communication paths, the time when the packets included in the first frame have been received is compared with the time T.

For example, in order to evaluate the first communication path, a difference between the first time and the time T is acquired. In order to evaluate the second communication path, a difference between the second time and the time T is acquired. In order to evaluate the third communication path, a difference between the third time and the time T is acquired.

The transmitting apparatus 101 determines that a communication path has a more sufficient communication bandwidth as the difference from the time T increases. Thus, more packets are assigned to a communication path having a more sufficient communication bandwidth.

In other words, the transmitting apparatus 101 determines how a plurality of packets included in a second frame to be transmitted later than the first frame are to be assigned based on the evaluation results of the communication paths.

It is assumed here that the first communication path is evaluated as having a larger communication bandwidth than that of the second communication path. It is further assumed that the second communication path is evaluated as having a larger communication bandwidth than that of the third communication path. In this case, a plurality of packets included in the second frame are transmitted such that the ratio (the number of packets transmitted by using the first communication path):(the number of packets transmitted by using the second communication path):(the number of packets transmitted by using the third communication path) may be 5:3:2, for example.

Thus, frame data of one frame may be transmitted such that packets included in the frame may arrive and be received by a receiving apparatus at a substantially same time through any of communication paths.

As described above, the receiving apparatus 102 may notify the transmitting apparatus 101 of a decoding delay state caused by a difference in transmission time between paths. Thus, the transmitting apparatus 101 may recognize the decoding delay state from the notification at a correct time. Therefore, it may be controlled so as to quickly determine sorting of packets for reduction of decoding delays. The notification according to this embodiment applies the procedure of general RTT measurement as described above, which eliminates the necessity for another MPRTCP packet.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-007811, filed Jan. 20, 2014, which is hereby incorporated by reference herein in its entirety.

1. A receiving apparatus comprising:
a receiving unit configured to receive encoded data in packets from a transmitting apparatus through a plurality of transmission paths including a first transmission path and a second transmission path; and
a notifying unit configured to notify the transmitting apparatus of information describing a time period from reception of a first packet containing data in units of decoding through the first transmission path to reception of a second packet containing data in the units of decoding through the second transmission path.

2. The receiving apparatus according to claim 1, further comprising measuring unit configured to measure an RTT representing a time period from transmission of data by the transmitting apparatus to reception by the transmitting apparatus of a response to the data from the receiving apparatus, wherein the notifying unit notifies the information along with a message returning the RTT.

3. The receiving apparatus according to claim 2, wherein the notifying unit notifies by using MPRTCP.

4. A transmitting apparatus comprising:
a transmitting unit configured to transmit an encoded content in packets to a receiving apparatus through a plurality of transmission paths including a first transmission path and a second transmission path; and
an acquiring unit configured to acquire from the receiving apparatus information describing a time period from reception of a first packet containing data in units of decoding through the first transmission path to reception of a second packet containing data in the units of decoding through the second transmission path.

5. The transmitting apparatus according to claim 4, wherein the acquiring unit acquires the information along with a message returning the RTT.

6. The transmitting apparatus according to claim 5, wherein the transmitting unit transmits the request by using MPRTCP.

7. A control method for a receiving apparatus comprising:
receiving encoded data in packets from a transmitting apparatus through a plurality of transmission paths including a first transmission path and a second transmission path; and
notifying the transmitting apparatus of information describing a time period from reception of a first packet containing data in units of decoding through the first transmission path to reception of a second packet containing data in the units of decoding through the second transmission path.

8. A control method for a transmitting apparatus comprising:
transmitting an encoded content in packets to a receiving apparatus through a plurality of transmission paths including a first transmission path and a second transmission path; and
acquiring from the receiving apparatus information describing a time period from reception of a first packet containing data in units of decoding through the first transmission path to reception of a second packet containing data in the units of decoding through the second transmission path.

9. A recording medium recording a program for causing a computer to execute
receiving encoded data in packets from a transmitting apparatus through a plurality of transmission paths including a first transmission path and a second transmission path; and
notifying the transmitting apparatus of information describing a time period from reception of a first packet containing data in units of decoding through the first transmission path to reception of a second packet containing data in the units of decoding through the second transmission path.

10. A recording medium recording a program for causing a computer to execute
transmitting an encoded content in packets to a receiving apparatus through a plurality of transmission paths including a first transmission path and a second transmission path; and
acquiring from the receiving apparatus information describing a time period from reception of a first packet containing data in units of decoding through the first transmission path to reception of a second packet containing data in the units of decoding through the second transmission path.

11. A communication system comprising a transmission apparatus and a receiving apparatus which is connected to the transmission apparatus via a plurality of transmission paths, wherein the transmission apparatus comprises:
a transmitting unit configured to transmit an encoded content in packets to a receiving apparatus through the plurality of transmission paths including a first transmission path and a second transmission path; and
an acquiring unit configured to acquire from the receiving apparatus information describing a time period from reception of a first packet containing data in units of decoding through the first transmission path to reception of a second packet containing data in the units of decoding through the second transmission path, and
the receiving apparatus comprises:
a receiving unit configured to receive encoded data in packets from the transmitting apparatus through the plurality of transmission paths; and
a notifying unit configured to notify the transmitting apparatus of information describing the time period from reception of the first packet containing data in units of decoding through the first transmission path to reception of the second packet containing data in the units of decoding through the second transmission path.
